(19) United States
(12) Patent Application Publication
(10) Pub. No.: US 2024/0367060 A1
(43) Pub. Date: Nov. 7, 2024

(54) SYSTEMS AND METHODS FOR ENABLING COMMUNICATION BETWEEN USERS

(71) Applicant: Sony Interactive Entertainment Inc., Tokyo (JP)

(72) Inventors: Andrew Young, San Mateo, CA (US); Celeste Bean, San Francisco, CA (US); Steven Osman, San Francisco, CA (US)

(21) Appl. No.: 18/593,580

(22) Filed: Mar. 1, 2024

Related U.S. Application Data
(60) Provisional application No. 63/464,165, filed on May 4, 2023.

(51) Int. Cl. A63F 13/87; A63F 13/533; A63F 13/56; A63F 13/65; A63F 13/812; G06F 3/01

(52) U.S. Cl. CPC A63F 13/87; A63F 13/533; A63F 13/56; A63F 13/65; A63F 13/812; G06F 3/017; A63F 2300/5553

(57) ABSTRACT

Systems and methods for enabling communication between users are described. One of the methods includes receiving, via a computer network, data regarding a plurality of real gestures made by a first user via a first user account. The data regarding the plurality of real gestures is received from a client device. The method further includes determining, from the data, whether a speed of occurrence of the plurality of real gestures is greater than a predetermined speed. After determining that the speed of occurrence of the plurality of real gestures is greater than the predetermined speed, the method includes determining one or more meanings of a combination of the plurality of real gestures. The method includes communicating the one or more meanings of the combination via a virtual avatar, controlled by the first user via the first user account, to a second user.

### CLAIM OF PRIORITY

The present patent application claims the benefit of and priority, under 35 USC § 119 (e), to U.S. provisional patent application No. 63/464,165, filed on May 4, 2023, and titled “SYSTEMS AND METHODS FOR ENABLING COMMUNICATION BETWEEN USERS”, which is incorporated by reference herein in its entirety.

### FIELD

The present disclosure relates to systems and methods for enabling communication between users are described.

### BACKGROUND

Video games are a popular entertainment activity that players can engage in through the use of a video game console or a personal computer. In server-based gaming systems, video game consoles and personal computers can be used to receive input from an attached game pad, keyboard, joystick or other game controller, process video game software, and display video game images on a connected television or monitor.

The video game consoles and personal computers also can be used for multi-player games. In the multi-player games, each player uses different game controllers that are coupled to the server-based gaming systems via the same game console or different game consoles. In the multi-player games, data is sent between the players over a computer network, and the players communicate with each other during a play of the multi-player games.

It is in this context that embodiments of the invention arise.

### SUMMARY

Embodiments of the present disclosure provide systems and methods for enabling communication between users.

In an embodiment, the methods for enabling communication between users include capturing real gestures, such as sign language gestures, and interpreting the real gestures, such as by adjusting a speed at which the real gestures are performed, to identify meanings of the real gestures. For example, a user, such as a sign language communicator, slurs signs or blends the real gestures and therefore, the real gestures are not readily identifiable on their own. Sometimes, the real gestures are quickly made and slurred together, and there it is difficult to communicate one or more meanings of the real gestures. To interpret the real gestures, different methods are applied. To illustrate, sometimes, speed between the real gestures is identified to distinguish between the real gestures. Image capture of the real gestures is slowed and/or sped up to analyze a type of communication intended by the user. Also, as another illustration, machine learning is used to identify slurred communication gestures. Once the real gestures are identified, future gesturing by the user can be adjusted before it is communicated to a target recipient.

In an embodiment, some of the real gestures that are slurred do not have any meaning, and are removed from a communicated output once translated. If the user is communicating too quickly, the systems for enabling communication between users filter out non-relevant information before a summary is output to an intended recipient. This is useful in games of strategy and speed, where not every single gesture is to be translated and a summary of the real gestures is provided. The summary of the real gestures is optimized based on a context of a game and/or a context of a specific time when one or more of the real gestures are generated. The summary of the real gestures provides a gist of what the communication is intended to be, and a detailed translation of the real gestures is not useful or not needed.

In one embodiment, a method for enabling communication between users is described. The method includes receiving, via a computer network, data regarding a plurality of real gestures made by a first user via a first user account. The data regarding the plurality of real gestures is received from a client device. The method further includes determining, from the data, whether a speed of occurrence of the plurality of real gestures is greater than a predetermined speed. After determining that the speed of occurrence of the plurality of real gestures is greater than the predetermined speed, the method includes determining one or more meanings of a combination of the plurality of real gestures. The method includes communicating the one or more meanings of the combination via a virtual avatar, controlled by the first user via the first user account, to a second user.

In an embodiment, a method for enabling communication between users is described. The method includes receiving, via a computer network, data regarding one or more real gestures made by a first user via a first user account. The method further includes determining, from the data, whether a speed of occurrence of the one or more real gestures is less than a preset speed. After determining that the speed of occurrence of the one or more real gestures is less than the preset speed, the method includes determining one or more meanings of the one or more real gestures. The method includes communicating the one or more meanings via a virtual avatar, controlled by the first user via the first user account, to a second user.

In one embodiment, a server system for enabling communication between users is described. The server system includes a processor and a memory device coupled to the processor. The processor receives, via a computer network, data regarding a plurality of real gestures made by a first user via a first user account. The data regarding the plurality of real gestures is received from a client device. The processor determines, from the data, whether a speed of occurrence of the plurality of real gestures is greater than a predetermined speed. After the determination that the speed of occurrence of the plurality of real gestures is greater than the predetermined speed, the processor determines one or more meanings of a combination of the plurality of real gestures. The processor communicates the one or more meanings of the combination via a virtual avatar, controlled by the first user via the first user account, to a second user.

Some advantages of the herein described systems and methods include allowing users, such as players, to communicate with each other. In a multi-user environment, such as a multi-player game, a first user communicates too quickly for a second user to understand. For example, the first user makes gestures too fast such they appear blurred to a camera capturing the gestures. As such, the second user is unable to determine some of the gestures that are made by the first user. As another example, the first user takes too long to make the gestures. The communication stalls or becomes inefficient. By using an artificial intelligence (AI) model to interpret the gestures made too quickly and providing meanings to the gestures, the first user is able to convey the meanings of the gestures to the second user in an efficient manner.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

Various embodiments of the present disclosure are best understood by reference to the following description taken in conjunction with the accompanying drawings in which:

FIG. 1A-1 is a diagram of an embodiment a system to illustrate multiple gestures that are performed by a user too quickly and interpretation of the gestures.

FIG. 1A-2 is a diagram of an embodiment of a system for implementing the methods for enabling communication between users described herein.

FIG. 1B is a diagram of an embodiment of a display device to illustrate a request indicating that the user repeat a real gesture.

FIG. 2A is a diagram of an embodiment of a system to illustrate that multiple gestures are performed by the user in a slow manner.

FIG. 2B is a diagram of an embodiment of a system to illustrate that a server system generates and provides a message for receiving gesture data of remaining real gestures when the user takes a long time to make the remaining real gestures.

FIG. 2C is a diagram of an embodiment of a system to illustrate a message indicating that the user train himself/herself on the remaining real gestures when the user takes a long time to make the remaining real gestures.

FIG. 3 illustrates components of an example device that can be used to perform aspects of the various embodiments of the present disclosure.

### DETAILED DESCRIPTION

Systems and methods for enabling communication between users are described. It should be noted that various embodiments of the present disclosure are practiced without some or all of these specific details. In other instances, well known process operations have not been described in detail in order not to unnecessarily obscure various embodiments of the present disclosure.

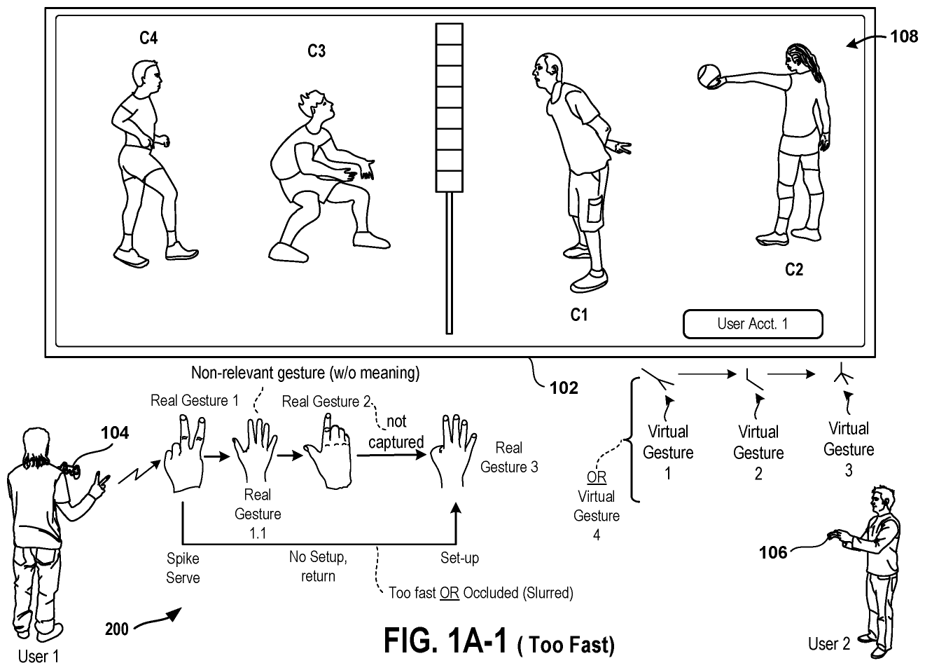

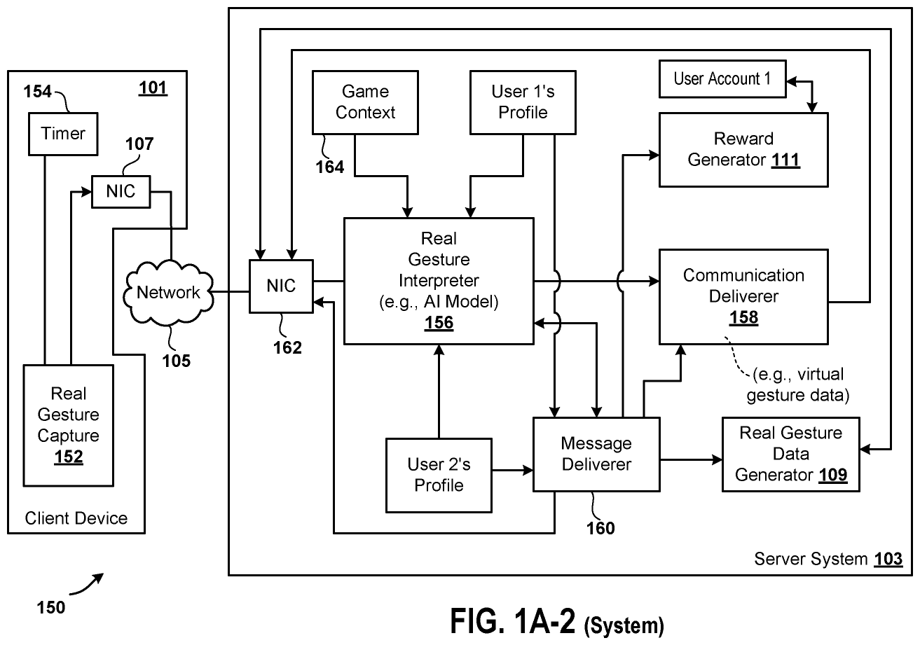

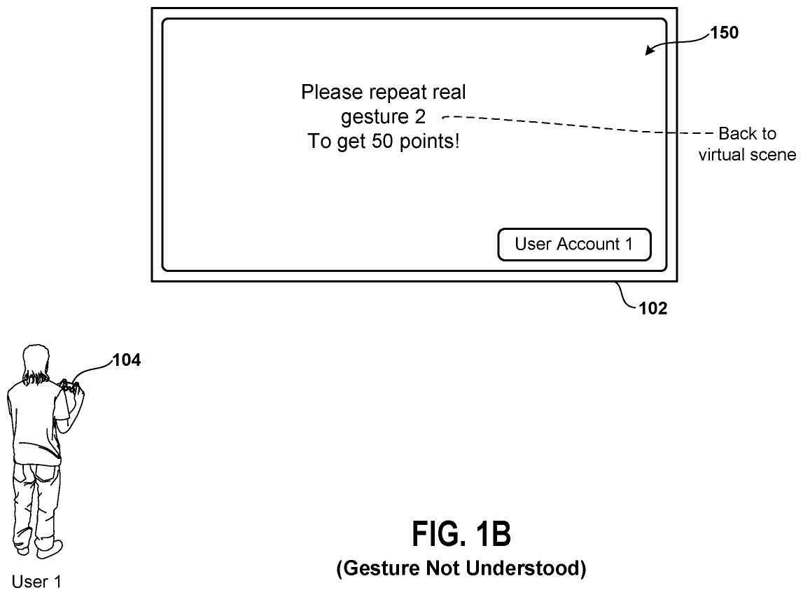

FIG. 1A-1 is a diagram of an embodiment a system 100 to illustrate multiple gestures performed by a user 1 too quickly and interpretation of the gestures. The system 100 includes a display device 102, a hand-held controller (HHC) 104, and another hand-held controller 106. Examples of a display device include a display of a computer, a display of a television, a display of a smart television, a display of a smart phone, and a head-mounted (HMD) display. To illustrate, the display device 102 is an HMD worn by the user 1. An example of a hand-held controller, as used herein, include a Sony PlayStation™ controller having joysticks and input buttons for receiving selections from a user holding the hand-held controller.

The display device 102 and the HHC 104 are components of a client device operated by the user 1. Moreover, another display device and the HHC 106 are components of a client device operated by the user 2. An example of a client device, as described herein, includes a combination of a game console, one or more cameras, a microphone, a display device, and a hand-held controller. Another example of the client device includes a combination of a computer, one or more input devices, one or more cameras, and a headphone having a microphone. Examples of an input device, as used herein, include a keyboard, an HHC, or a keypad, a mouse, a stylus, a microphone, and a touchscreen.

The user 1 uses the hand-held controller 104 and the user 2 uses the hand-held controller 106 to access a computer software program, such as a multi-player video game program, or a sign language program, or a video conferencing program, from a server system. For example, the user 1 uses the hand-held controller 104 to log into a user account 1 stored on the server system to access a virtual scene 108 displayed on the display device 102. Data for displaying the virtual scene 108 is generated by the server system by execution of the computer software program. In the example, the data for displaying the virtual scene 108 is generated by the server system upon execution of the multi-player video game program for playing a volleyball video game. Moreover, in the example, the user 2 logs into another user account, assigned to the user 2, to access the computer software program. The server system assigns the user account 1 to the user 1 and the other user account to the user 2.

As an example, the server system includes one or more servers, and each of the one or more servers include one or more processors and one or more memory devices. To illustrate, the one or more processors or coupled to the one or more memory devices. An example of the multi-player video game program is a program executed by the server system to allow a user to play the volleyball video game or a car racing video game or a boxing video game.

During the execution of the computer software program by the server system, the user 1 makes one or more real gestures, such as sign language gestures or gameplay gestures, or uses the hand-held controller 104 or a combination thereof to control a virtual character C1, such as movements of the virtual character C1 or sounds output from the virtual character C1, in the virtual scene 108. Examples of the one or more real gestures include a real gesture 1, a real gesture 1.1, a real gesture 2, and a real gesture 3. To illustrate, the user 1 extends two fingers of his/her hand to make the real gesture 1, extends all five fingers of the hand to make the real gesture 1.1, extends an index finger of the hand to make the real gesture 2, and extends three fingers of the hand to make the real gesture 3. In the illustration, the real gesture 1.1 is made consecutive to the real gesture 1, the real gesture 2 is made consecutive to the real gesture 1.1, and the real gesture 3 is made consecutive to the real gesture 2. To further illustrate, there is no real gesture between the real gestures 1 and 1.1 for the real gestures 1 and 1.1 to occur in a consecutive sequence, no real gesture between the real gestures 1.1 and 2 for the real gestures 1.1 and 2 to occur in a consecutive sequence, and no real gesture between the real gestures 2 and 3 for the real gestures 2 and 3 to occur in a consecutive sequence. Further examples of one or more real gestures, described herein, made by a user, include an eye gaze of the user or a head movement of the user or a leg movement of the user or a sound output by the user or a combination thereof.

In the volleyball video game, similarly, the user 2 makes one or more real gestures or uses the hand-held controller 106 or a combination thereof to control a virtual character C2, such as movements of the virtual character C2 or sounds output from the virtual character C2, in the virtual scene 108. Moreover, similarly, another user makes one or more real gestures or uses a hand-held controller (not shown) or a combination thereof to control a virtual character C3 in the virtual scene 108, and yet another user makes one or more real gestures or uses a hand-held controller (not shown) or a combination thereof to control a virtual character C4 in the virtual scene 108. The virtual characters C1 and C2 belong to a first team in the virtual characters C3 and C4 belong to a second team.

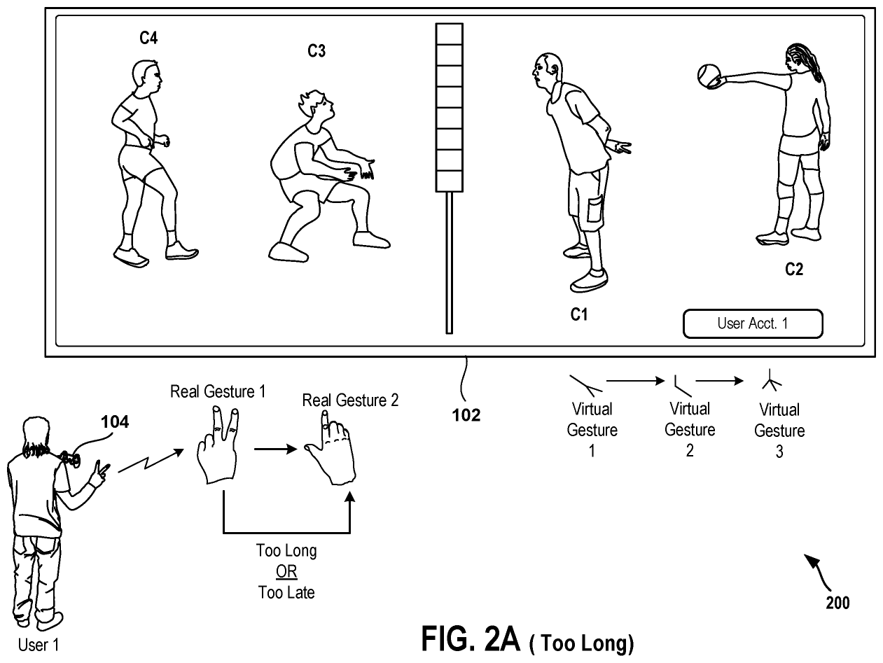

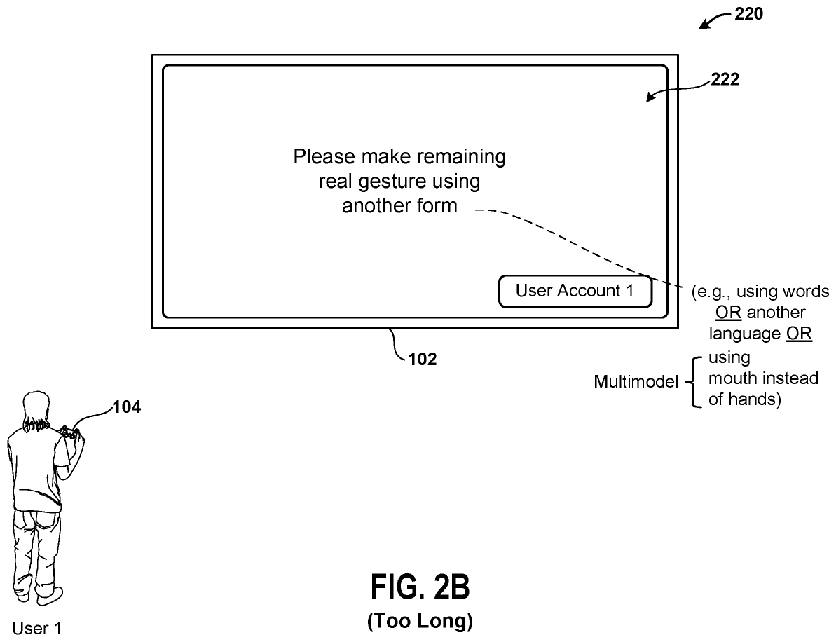

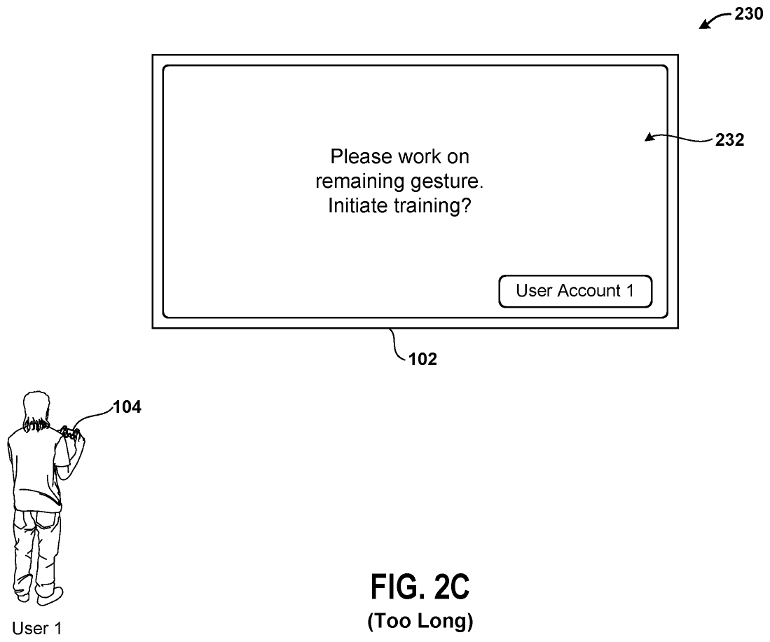

The real gesture 1.1 cannot be interpreted by the server system. To illustrate, an artificial intelligence (AI) model, which is a computer program executed by the server system, cannot determine, with a predetermined probability, a meaning of the real gesture 1.1 based on a context of the volleyball video game, a user profile 1 (FIG. 1A-2) of the user 1, and comparison of the real gesture 1.1 with real gestures that are used to train the AI model. In the illustration, the context of the volleyball video game is that the volleyball video game to be played until 12 points is about to start or that in volleyball video game, the second team is about to start serving a virtual volleyball after winning six points in the volleyball video game. Further in the illustration, the comparison indicates that the real gesture 1.1 is not made by a majority of other users, such as the user 2, during the context of the volleyball video game. In the illustration, the user profile 1 of the user 1 does not identify that the real gesture 1.1 has a meaning. The real gesture 1.1 is an example of an irrelevant gesture.

FIG. 1A-2 is a diagram of an embodiment of a system 150. The system 150 includes a client device 101, a server system 103, and a computer network 105. The client device 101 includes a real gesture capturer 152, a timer 154, and a network interface controller (NIC) 107. The server system 103 includes a real gesture interpreter 156, a communication deliverer 158, a message deliverer 160, a NIC 162, a game context 164, the user profile 1, a user profile 2 of the user 2, a real gesture data generator 109, and a reward generator 111. An example of the real gesture capturer 152 includes one or more cameras, such as a gaze tracking camera, or one or more microphones or one or more inertial sensors or a combination of two or more thereof. To illustrate, the real gesture capturer 152 is located within an HMD worn by the user 1. As another illustration, the real gesture capturer 152 is located in the same real-world environment, such as the same room, in which the user 1 is located. To further illustrate, the camera of the real gesture capturer 152 is located outside the HMD worn by the user 1 and in the same room in which the user 1 is located. As yet another illustration, the real gesture capturer 152 is located within the HHC 104 held by the user 1. As an illustration, the camera of the real gesture capturer 152 captures image data of real gestures that are made by a user, the microphone of the real gesture capturer 152 converts sounds output by the user into audio data, such as electrical signals, and one or more inertial sensors of the real gesture capturer 152 converts movements of head or arms or fingers or another body part of the user into inertial sensor data. Examples of a real gesture made by a user includes a movement of an arm of the user or a finger of the user or an eye of the user or head of the user or sounds output by the user or a combination thereof.

As an example, a NIC of a sender system, such as the client device 101 or the server system 103, applies a network protocol, such as a transmission control protocol over Internet protocol (TCP/IP), to generate packets. Examples of a NIC include a network interface card. The packets are generated to include data to be sent to a destination system, an address of the destination system, and an address of a component of the destination system. Examples of the sender system include the server system 103 and the client device 101. The NIC of the sender system sends the packets via the computer network 105 to the destination system. In the example, a NIC of the destination system receives the packets and applies the network protocol to extract the data from the packets, identifies the component of the destination system to which the data is addressed, and sends the data to the component of the receiver system. Examples of the components of the sever system 103 include the real gesture interpreter 156, the communication deliverer 158, the message deliverer 160, the real gesture data generator 109, and the reward generator 111. Examples of the components of the client device 101 include the real gesture capturer 152, the timer 154, a display device of the client device 101, and one or more speakers of the client device 101.

Examples of a computer network, as used herein, include the Internet, an intranet, and a combination of Internet and the intranet. Examples of the server system 103 are provided above. Also, examples of the client device 101 are provided above. For example, the client device 101 is an example of the client device operated by the user 1 or the client device operated by the user 2.

Each of the real gesture interpreter 156, the communication deliverer 158, the message deliverer 160, the real gesture data generator 109, and the reward generator 111 is implemented in hardware or software. Examples of hardware include an application specific integrated circuit (ASIC), a central processing unit (CPU), a programmable logic device (PLD), a field programmable gate array (FPGA), a microcontroller, and a microprocessor. Examples of software include a computer program. To illustrate, the real gesture interpreter 156 is the first ASIC, the communication deliverer 158 is a second ASIC, and the message deliverer 160 is a third ASIC. As another illustration, the real gesture interpreter 156 is a first computer program, the communication deliverer 158 is a second computer program, and the message deliverer 160 is a third computer program. As yet another illustration, the real gesture interpreter 156 is a first portion of a computer program, the communication deliverer 158 is a second portion of the computer program, and the message deliverer 160 is a third portion of the computer program.

The real gesture capturer 152 is coupled to the timer 154. Also, the real gesture capturer 152 is coupled to the real gesture interpreter 156 via the NIC 105, the computer network 105, and the NIC 162. The communication deliverer 158 is coupled to the real gesture interpreter 156 and to the NIC 162, and the message deliverer 160 is coupled to the communication deliverer 158. The message deliverer 160 is also coupled to the NIC 162. The real gesture interpreter 156 is coupled to the message deliverer 160. The real gesture data generator 109 is coupled to the NIC 162 and to the message deliverer 160. The message deliverer 160 is coupled to the reward generator 111, which is coupled to the user account 1 stored in the one or more memory devices of the server system 103. The real gesture data generator 109 is coupled to the message deliverer 160 and to the NIC 162.

With reference to FIGS. 1A-1 and 1A-2, the user 1 makes one or more of the real gestures 1, 1.1, 2, and 3 quickly, and the real gesture 2 appears blurred to the real gesture capturer 152. For example, the real gesture 2 is made so fast by the user 1 that the real gesture 2 is not captured by the real gesture capturer 152. As another example, the real gesture 2 is partially made or not made by the user 1 in between the real gestures 1 and 3. To illustrate, the user 1 forgets to make or finish making the real gesture 2. As another example, the real gesture 2 is blended with another gesture, such as the gesture 1 or the gesture 3 or the gesture 1.1, for the real gesture capturer 152 to be unable to identify the real gesture 2 separately from the other gesture. To illustrate, the real gesture 2 appears slurred to the real gesture capturer 152. As yet another example, the real gesture 2 is occluded from the real gesture capturer 152. To illustrate, an object, such as another user or a nonliving item, such as a television screen, hides the real gesture 2 from a camera of the real gesture capturer 152.

The real gesture capturer 152 captures real gesture data, such as image data or audio data or inertial sensor data, of the one or more real gestures, such as the real gestures 1, 1.1, 2, and 3 or the real gesture 1, a portion of the real gesture 2, and the real gesture 3 or the real gesture 1, the real gesture 1.1, a portion of the real gesture 2, and the real gesture 3 or the real gestures 1, 1.1, and 3, and sends the real gesture data to the real gesture interpreter 156 of the server system 103 via the NIC 107, the computer network 105, and the NIC 162. For example, the real gesture capturer 152 does not capture the real gesture 2.

Also, the timer 154 measures one or more times of occurrences of the one or more real gestures made by the user 1 and provides the one or more times to the real gesture capturer 152. The real gesture capturer 152 sends the one or more times of occurrences with the real gesture data of the one or more real gestures via the NIC 107, the computer network 105, and the NIC 162 to the real gesture interpreter 156.

The real gesture interpreter 156 of the server system 103 receives the real gesture data and the time data from the real gesture capturer 152 via the computer network 105 and the user account 1 and interprets the real gesture data and the time data to determine virtual gesture data of one or more virtual gestures. As an example, the real gesture interpreter 156 parses the real gesture data to slow down a speed of occurrences of the real gesture data to identify the real gestures 1, 1.1, 2, and 3. To illustrate, the real gesture interpreter 156 parses the real gesture data to compare a first portion of the real gesture data with first pre-stored real gesture data within the one or more memory devices of the server system 103 to determine that the first portion is of the real gesture 1. Similarly, in the illustration, the real gesture interpreter 156 parses the real gesture data to compare a second portion of the real gesture data with second pre-stored real gesture data within the one or more memory devices of the server system 103 to determine that no portion of pre-stored real gesture data matches the real gesture 1.1, parses the real gesture data to compare a second portion of the real gesture data with second pre-stored real gesture data within the one or more memory devices of the server system 103 to determine that the second portion is of the real gesture 2, and parses the real gesture data to compare a third portion of the real gesture data with third pre-stored real gesture data within the one or more memory devices of the server system 103 to determine that the third portion is of the real gesture 3.

As another example, the real gesture interpreter 156, such as the AI model, receives the real gesture data from the real gesture capturer 152 and interprets the real gesture data to identify one or more of the real gestures 1, 1.1, 2, and 3 made by the user 1 and determines one or more meanings of the one or more of the real gestures 1, 1.1, 2, and 3. In the example, the real gesture data is received via the user account 1 when the real gesture data is generated after the user 1 logs into the user account 1. In the example, the real gesture interpreter 156 compares a parameter, such as a shape or size or color or graphics or intensity or shade or an amplitude or a frequency or change in position or a change in orientation or a combination thereof, of the real gesture data received via the user account 1 with predetermined parameters of other real gesture data previously received from client devices operated by other users via other user accounts or from the client device 101 operated by the user 1 via the user account 1 or a combination thereof to determine a similarity, such as sameness, between the real gesture data and the other real gesture data. To illustrate, the real gesture interpreter 156 compares a shape of the real gesture data of a real gesture n with shapes of real gestures indicated by the other real gesture data to determine that the shape of the real gesture n is within a predetermined range from the shapes of the real gestures of the other real gesture data to further determine that the real gesture n is to extend two fingers of one hand or to extend three fingers of the hand, where n is a positive real number. Examples of the positive real number n include 1, 1.1, 2 and 3. In the illustration, upon determining that the shape of the real gesture n is within the predetermined range, the real gesture interpreter 156 determines that a meaning of the real gesture n can be interpreted to further determine that the real gesture n can be identified. In the illustration, on the other hand, upon determining that the shape of the real gesture n is outside the predetermined range, the real gesture interpreter 156 determines that a meaning of the real gesture n cannot be interpreted to further determine that the real gesture n cannot be identified. In the example, the other real gesture data is received during execution of the computer software program, and the computer software program is executed during the same session as that of execution of the computer software program in which the real gesture data is received based on the real gesture n performed by the user 1 or a different session than the session of execution of the computer software program in which the real gesture data is received based on the real gesture n. To illustrate, a session occurs when a user logs into his/her user account and ends when the user logs out of the user account. As another illustration, a session ends when the user turns off a client device operated by the user.

As another illustration, the real gesture interpreter 156 compares an amplitude, such as an amplitude of audio data, of the real gesture data indicated by the real gesture n with amplitudes of the other real gesture data to determine that the amplitude of the real gesture data indicated by the real gesture n is within a predetermined range from the amplitudes of the other real gesture data to further determine that the real gesture n is similar to the other real gestures. In the illustration, upon determining that the amplitude of the real gesture data indicated by the real gesture n is within the predetermined range from the amplitudes of the other real gesture data, the real gesture interpreter 156 determines that a meaning of the real gesture n can be interpreted to further determine that the real gesture n can be identified. In the illustration, on the other hand, upon determining that the amplitude of the real gesture data indicated by the real gesture n is outside the predetermined range from the amplitudes of the other real gesture data, the real gesture interpreter 156 determines that a meaning of the real gesture n cannot be interpreted to further determine that the real gesture n cannot be identified.

As another illustration, the real gesture interpreter 156 compares a frequency, such as a frequency of audio data, of the real gesture data generated based on the real gesture n with frequencies of the other real gesture data to determine that the frequency of the real gesture data of the real gesture n is within a predetermined range from the frequencies of the other real gesture data to further determine that the real gesture n is similar to the other real gestures. In the illustration, upon determining that the frequency of the real gesture data generated based on the real gesture n is within the predetermined range from the frequencies of the other real gesture data, the real gesture interpreter 156 determines that a meaning of the real gesture n can be interpreted to further determine that the real gesture n can be identified. In the illustration, on the other hand, upon determining that the frequency of the real gesture data indicated by the real gesture n is outside the predetermined range from the frequencies of the other real gesture data, the real gesture interpreter 156 determines that a meaning of the real gesture n cannot be interpreted to further determine that the real gesture n cannot be identified.

As yet another illustration, the real gesture interpreter 156 compares inertial sensor data generated based on the real gesture n with inertial sensor data of the other real gesture data to determine that the inertial sensor data generated based on the real gesture n is within a predetermined range from the inertial sensor data of the other real gesture data to further determine that the real gesture n is similar to the other real gestures. In the illustration, upon determining that the inertial sensor data generated based on the real gesture n is within the predetermined range from the inertial sensor data of the other real gesture data, the real gesture interpreter 156 determines that a meaning of the real gesture n can be interpreted to further determine that the real gesture n can be identified. In the illustration, on the other hand, upon determining that the inertial sensor data generated based on the real gesture n is outside the predetermined range from the inertial sensor data of the other real gesture data, the real gesture interpreter 156 determines that a meaning of the real gesture n cannot be interpreted to further determine that the real gesture n cannot be identified.

Further, in the example, upon determining that the real gesture n is identified, the real gesture interpreter 156 determines whether the real gesture n has occurred with a speed greater than a predetermined speed from a previously performed real gesture, such as a real gesture (n-m), or whether the real gesture n is irrelevant to the game context 164, where m is an integer less than n. To illustrate, the real gesture interpreter 156 accesses the computer software program to determine whether the real gesture n is identified, such as included, within the computer software program. In the illustration, upon determining that the real gesture n is not included within the computer software program, the real gesture interpreter 156 determines the real gesture n, such as the real gesture 1.1, to be irrelevant and indicates to the communication deliverer 158 to not control the virtual character C1 based on the real gesture n.

Further, in the illustration, upon determining that the real gesture n is included within the computer software program as one or real gestures than can be used to control the virtual character C1, the real gesture interpreter 156 determines the real gesture n as relevant and determines or identifies a time of occurrence N of the real gesture n, where N is a positive real number. In the illustration, the real gesture (n-m) is the real gesture 1 and the real gesture n is the real gesture 3. In the illustration, the time of occurrence N is identified from the time data received with the real gesture data from the client device 101. In the illustration, the real gesture interpreter 156 determines or identifies from the times of occurrences received with the real gesture data based on which the real gesture n is identified that the real gesture n occurs at the time of occurrence N. Also, in the illustration, the real gesture interpreter 156 identifies from the times of occurrences received with the real gesture data from which the real gesture (n-m) is identified that the real gesture (n-m) occurs at a time of occurrence (N-a), where a is a positive real number less than N. Further, in the illustration, the real gesture interpreter 156 calculates a difference between the times N and (N-a) to determine a time difference between occurrences of the real gestures n and (n-m). In the illustration, the real gesture interpreter 156 determines that the time difference is less than a predetermined time difference to determine that the speed of occurrence of the real gesture n is greater than the predetermined speed.

In the example, upon determining that the speed of occurrence of the real gesture n is greater than the predetermined speed, the real gesture interpreter 156 determines based on the other real gesture data that the real gesture 2 is performed by the user 1 in between the performance of the real gestures 1 and 3. To illustrate, the real gesture interpreter 156 determines from the other real gesture data that during a time period in which contexts similar to the game context 162 having the virtual scene 108 is displayed on the other client devices operated by the other users, that the other users perform for greater than a predetermined number of times a real gesture, similar to the real gesture 2, in between performing real gestures, similar to the real gestures 1 and 3, to further determine that the real gesture 2 is performed by the user 1 during a play of the volleyball video game. In the illustration, upon determining that the real gesture, similar to the real gesture 2, is performed for greater than the predetermined number of times, the real gesture interpreter 156 determines that there is a probability or that it is more likely than not that the user 1 performs the real gesture 2 in between performing the real gestures 1 and 3. In the illustration, the contexts are similar to the game context 162 having the virtual scene 108 when the contexts are virtual scenes of the volleyball video game in which a first virtual character, in a team, is about to serve and a second virtual character, in the same team, provides virtual gestures to the first virtual character.

In the example, upon determining that the real gestures 1, 2, and 3 are performed by the user 1 and determining that the real gesture 1.1 is irrelevant, the real gesture interpreter 156 interprets meanings of the one or more real gestures received via the user account 1. To illustrate, the real gesture interpreter 156 interprets a meaning of the real gesture 1 to be a virtual gesture 1, a meaning of the irrelevant real gesture 1.1 to be irrelevant, such as nonexistent, to the computer software program, a meaning of the real gesture 2, which is blurred, to be a virtual gesture 2, and a meaning of the real gesture 3 to be a virtual gesture 3 to determine the meanings of a combination of the real gestures 1, 1.1, 2, and 3. In the illustration, the real gesture interpreter 156 provides the meanings of the real gestures 1, 2 and 3 to the communication deliverer 158 without providing the meaning of the irrelevant real gesture 1.1, and the communication deliverer 158 generates virtual gesture data for displaying the virtual gestures 1, 2, and 3 to be performed by the virtual character C1, and sends the virtual gesture data via the computer network 105 to the client device operated by the user 2. Further in the illustration, upon receiving the virtual gesture data, the client device operated by the user 2 displays the virtual gestures 1 through 3 as being performed by the virtual character C1.

In the illustration, in the volleyball video game, the virtual gesture 1 performed by the virtual character C1 indicates to the user 2 a meaning in which the virtual character C2 is to be controlled by the user 2 via the client device operated by the user 2 to make a spike serve, the virtual gesture 2 performed by the virtual character C1 indicates to the user 2 a meaning in which the virtual character C2 is to be controlled by the user 2 via the client device operated by the user 2 to return the virtual volleyball to the second team without a setup, and the virtual gesture 3 performed by the virtual character C1 indicates to the user 2 a meaning in which the virtual character C2 is to be controlled by the user 2 via the client device operated by the user 2 to create the setup. In the illustration, the setup occurs when the user 2 controls the virtual character C2 via the client device operated by the user 2 to lift the virtual volleyball gently to enable the user 1 to control the virtual character C1 to spike the virtual volleyball. In the illustration, the making of the spike server, the returning of the virtual volleyball to the second team without the setup, and the step are examples of the meanings of the real gestures 1, 2, and 3, and the meanings are conveyed to the user 2 via outputting, such as displaying or playing via speakers, the virtual gestures 1 through 3.

In the illustration, the real gesture interpreter 156 determines one or more of the meanings of one or more of the real gestures 1, 2, and 3 based on the game context 164 of the volleyball video game. To further illustrate, the real gesture interpreter 156 determines that the game context 164 of the volleyball video game includes that the virtual character C2 is about to serve and the virtual character C1 is to signal the virtual character C2 how to serve and includes a predetermined number of plays, such as a couple of plays, after the serve.

Also, in the illustration, the real gesture interpreter 156 determines one or more of the meanings of one or more of the real gestures 1, 2, and 3 based on the user profile 1 of the user 1 or the user profile 2 of the user 2 or a combination thereof. In the illustration, the real gesture interpreter 156 determines to modify the meanings of one or more of the real gestures 1, 2, and 3 based on one or more customized meanings indicated within the user profile 1 or the user profile 2 or a combination thereof. To further illustrate, the real gesture interpreter 156 accesses the user profiles 1 or 2 or a combination thereof to identify one or more of the customized meanings of one or more of the real gestures 1, 2, and 3. In the further illustration, the user profile 1 includes one or more of the customized meanings of one or more of the real gestures 1, 2, and 3. In the further illustration, the user 1 indicates to the real gesture interpreter 156 via the client device 101 operated by the user 1 the one or more of the customized meanings, meant by the user 1, of the one or more of the real gestures 1, 2, and 3. Moreover, in the further illustration, the real gesture interpreter 156 determines based on the user profile 2 whether the user 2 can understand the one or more of the customized meanings of the one or more of the real gesture 1 through 3. In the further illustration, upon determining that the user profile 2 indicates that the user 2 can understand the one or more of the customized meanings of the one or more of the real gesture 1 through 3, the real gesture interpreter 156 does not determine to control the virtual character C1 to modify the one or more of the customized meanings of the one or more of the real gesture 1 through 3. On the other hand, upon determining that the user profile 2 indicates that the user 2 cannot understand the one or more of the customized meanings of the one or more of the real gesture 1 through 3, the real gesture interpreter 156 determines to control the virtual character C1 to modify the one or more of the customized meanings of the one or more of the real gesture 1 through 3. In this manner, by considering the other real gesture data, the game context 164, and one or more of the user profiles 1 and 2, the meanings of the real gestures 1 through 3 are determined by the real gesture interpreter 156 to control the virtual character C1 based on the meanings.

Further in the illustration, the virtual gesture 1 is made by the virtual character C1 when its hands are behind its back and it extends its index and middle fingers to indicate to the user 2 to control the virtual character C2 to make the spike serve. Moreover, in the illustration, the virtual gesture 2 is made by the virtual character C1 when it extends its hands behind its back and extends its index finger to indicate to the user 2 to control the virtual character C2 to return the virtual volleyball to the second team without the setup, and the virtual gesture 3 is made by the virtual character C1 when it extends its hands behind its back and extends three fingers to indicate to the user 2 to control the virtual character C2 to make the setup. It should be noted that a user controls a virtual character by performing one or more gestures or by using a hand-held controller or a combination thereof.

As another illustration, the real gesture interpreter 156 interprets a summarized meaning of the real gestures 1, 1.1, 2, and 3 to be one or more virtual gestures. In the illustration, the real gesture interpreter 156 interprets the summarized meaning to be a virtual gesture 4, such as a high five or a thumbs up, to determine the summarized meaning of a combination of the real gestures 1, 1.1, 2, and 3. The virtual gesture 4 is an example of a summarized virtual gesture. In the illustration, the communication deliverer 158 generates virtual gesture data for displaying the virtual gesture 4 to be performed by the virtual character C1, and sends the virtual gesture data via the computer network 105 to the client device operated by the user 2. Further in the illustration, upon receiving the virtual gesture data, the client device operated by the user 2 displays the virtual gesture 4 as being performed by the virtual character C1.

In the illustration, in the volleyball video game, the virtual gesture 4 performed by the virtual character C1 indicates to the user 2 the summarized meaning in which the virtual character C2 is to be controlled by the user 2 via the client device operated by the user 2 to make the spike serve, to return the virtual volleyball to the second team without the setup, and then to create the setup. In the illustration, a combination of the making of the spike serve, the returning of the virtual volleyball to the second team without the setup, and the step is an example of the summarized meaning of the real gestures 1, 2, and 3, and the summarized meaning is conveyed to the user 2 by outputting, such as displaying the virtual character C1 to perform, the virtual gesture 4.

In the illustration, the real gesture interpreter 156 determines the summarized meaning of the real gestures 1, 2, and 3 based on the game context 164 of the volleyball video game, or the user profile 1 of the user 1, or the user profile 2 of the user 2, or a predetermined number of user profiles of the predetermined number of the other users, or a combination thereof. To further illustrate, the real gesture interpreter 156 determines that the game context 164 of the volleyball video game is that the virtual character C2 is about to serve, the virtual character C1 is to signal the virtual character C2 how to serve, the predetermined number of plays, such as a couple of plays, are to occur after the serve. In the further illustration, the real gesture interpreter 156 accesses the user profile 1 or the predetermined number of the user profiles of the predetermined number of the other users or a combination thereof to identify the summarized meaning of the real gestures 1, 2, and 3. In the further illustration, the summarized meaning of the real gestures 1, 2, and 3 is that identified within the user profile 1 or within the predetermined number of the user profiles of the predetermined number of the other users. In the further illustration, the user profile 1 includes the summarized meaning of the real gestures 1, 2, and 3 or the predetermined number of the user profiles includes a predetermined number of summarized meanings of real gestures similar to the real gestures 1 through 3. In the further illustration, the user 1 indicates to the real gesture interpreter 156 via the client device operated by the user 1 the summarized meaning of the real gestures 1, 2, and 3 or the predetermined number of the other users indicate to the real gesture interpreter 156 via the client devices operated by the predetermined number of the other users the predetermined number of summarized meanings of the real gestures similar to the real gestures 1, 2, and 3. Moreover, in the further illustration, the real gesture interpreter 156 determines based on the user profile 2 whether the user 2 can understand the summarized meaning of the real gestures 1 through 3. In the further illustration, upon determining that the user profile 2 indicates that the user 2 can understand the summarized meaning of the of the real gesture 1 through 3, the real gesture interpreter 156 does not determine to control the virtual character C1 to modify the summarized meaning of the real gestures 1 through 3. On the other hand, upon determining that the user profile 2 indicates that the user 2 cannot understand the summarized meaning of the real gestures 1 through 3, the real gesture interpreter 156 determines to control the virtual character C1 to modify the summarized meaning of the real gestures 1 through 3. In the further illustrate, the user 2 indicates via the client device operated by the user 2 whether the user 2 is able to understand the summarized meaning of the real gestures 1 through 3. Further in the illustration, the virtual gesture 4 is made by the virtual character C1 when it is controlled by the communication deliverer 158 to move its hands behind its back and extends its thumb to indicate to the user 2 to control the virtual character C2 to make the spike serve, to return the virtual volleyball to the second team without the setup and then to make the setup.

In an embodiment, instead of four real gestures 1, 1.1, 2, and 3 illustrated in FIG. 1A-1, any number of real gestures are performed by the user 1.

In one embodiment, instead of a user controlling a character, the one or more processors of the server system 103 or the AI model controls the character.

Moreover, in an embodiment, instead of the three virtual gestures 1 through 3 performed by the character C1, any number of virtual gestures are performed by the character C1.

In one embodiment, instead of the virtual gesture 4 performed by the character C1, any number of virtual gestures are performed by the character C1 as a summarized virtual gesture.

FIG. 1B is a diagram of an embodiment of the display device 102 to illustrate a request 150, such as a message, indicating that the user 1 repeat the real gesture 2, such as the real gesture 2. Upon determining, by the real gesture interpreter 156 (FIG. 1A-2), that the real gesture 2 is blurred and therefore, cannot be interpreted, the real gesture interpreter 156 sends an indication of the non-interpretation to the message deliverer 160 (FIG. 1A-2) of the server system 103. Upon receiving the indication of the non-interpretation, the message deliverer 160 of the server system 103 generates request data, such as prompt data, for displaying the request 150 and sends the request data via the computer network to the client device 101 (FIG. 1A-2) operated by the user 1. For example, the request 150 includes that the user 2 repeat the real gesture 2 for a reward of virtual points, such as 50 points or 100 points, in the volleyball video game. Moreover, upon receiving the indication of the non-interpretation, the message deliverer 160 generates button data for display buttons, such as an accept button and a deny button, indicating whether the user 1 will accept or deny the request 150, and sends the button data via the computer network 105 to the client device 101 operated by the user 1.

Upon receiving the request data for displaying the request 150 and the button data, the client device 101 operated by the user 1 displays the request 150 and the buttons on the display device 102. In response to receiving an indication of a selection, via one or more input devices, operated by the user 1, of the accept button for accepting the request 150, the client device 101 operated by the user 1 sends the indication via the NIC 107, the computer network 105, and the NIC 162 (FIG. 1A-2) to the message deliverer 160 of the server system 103. Upon receiving the indication of the selection of the accept button, the message deliverer 160 generates a signal including the indication of the selection of the accept button and sends the signal to the communication deliverer 158 of the server system 103. The communication deliverer 158 generates virtual scene data for displaying the same one or more virtual scenes, such as the virtual scene 108, previously displayed on the display device 102 to instigate the user 1 to repeat the real gesture 2. The communication deliverer 158 sends the virtual scene data to the NIC 162 of the server system 162. The NIC 162 sends the virtual scene data via the computer network 105 to the client device 101 operated by the user 1. Upon receiving the virtual scene data, the client device 101 operated by the user 1 displays the same one or more virtual scenes, such as the virtual scene 108, previously displayed on the display device 102, to allow the user 2 to repeat the real gesture 2.

Also, the message deliverer 160 sends a reward signal to the reward generator 111 upon receiving the indication of the selection of the accept button. Upon receiving the reward signal, the reward generator 111 adds the reward indicated in the request data to the user account 1.

The real gesture capturer 152 captures the real gesture 2, performed again by the user 1, to generate additional gesture data, and sends the additional gesture data via the NIC 107, the computer network 105, and the NIC 162 to the real gesture interpreter 156 of the server system 103. The real gesture interpreter 156 receives the additional gesture data, and interprets the real gesture 2 to identify a meaning of the real gesture 2 and provides the meaning to the communication deliverer 158. The communication deliverer 158 generates virtual gesture data for displaying the virtual gesture 2 based on the meaning of the real gesture 2. The communication deliverer 158 sends the virtual gesture data for displaying the virtual gesture 2 as being performed by the virtual character C1 via the computer network 105 to the client device operated by the user 2. Upon receiving the virtual gesture data for displaying the virtual gesture 2, the client device operated by the user 2 displays the virtual gesture 2 as being performed by the virtual character C1.

FIG. 2A is a diagram of an embodiment of a system 200 to illustrate multiple gestures that are performed by the user 1 in a slow manner. For example, it takes too long for the user 1 to make the real gesture 2 after making the real gesture 1. To illustrate, the user 1 takes a long time to make a portion of the real gesture 2 after making the real gesture 1. As another illustration, the user 1 takes a long time to finish the real gesture 2 after making a portion of the real gesture 2. The system 200 includes the display device 102 and the hand-held controller 104. The user 1 accesses the volleyball video game via the user account 1. During a play of the volleyball video game, the user 1 takes a large amount of time to make the real gesture 2 after making the real gesture 1.

An indication of an amount of time, such as a time interval taken between making the real gesture 1 and the real gesture 2 or a time interval during making the real gesture 1 or a time interval between making the real gesture 1 and a portion of the real gesture 2, and incomplete gesture data generated based on the real gesture 1 or the real gesture 1 and a portion of the real gesture 2 are sent from the client device 101 operated by the user 1 to the server system 103 (FIG. 1A-2) via the computer network 105 (FIG. 1A-2). For example, the timer 154 (FIG. 1A-2) measures the amount of time taken between capturing the real gesture 1 and the real gesture 2, and sends the amount of time to the real gesture capturer 152. The real gesture capturer 152 sends the amount of time and the incomplete gesture data via the NIC 107, the computer network 105 and the NIC 162 to the real gesture interpreter 156 (FIG. 1A-2) of the server system 103.

Upon receiving the amount of time and the incomplete gesture data, the real gesture interpreter 156 determines the meaning of the real gesture 1, the meaning of the real gesture 2, which is not performed or partially performed, and the meaning of the real gesture 3 based on the gesture data of the real gesture 1 or the real gesture 1 and the portion of the real gesture 2, the amount of time, one or more of the contexts of the volleyball video game, or one or more of the user profiles 1 and 2, or a combination thereof. For example, the real gesture interpreter 156 compares the amount of time within a preset time interval. In the example, upon determining that the amount of time exceeds the preset time interval, the AI model of the real gesture interpreter 156 determines that a speed of occurrence of the real gestures 1 and 2 is less than a preset speed. Further, in the example, upon determining that the speed of occurrence of the real gestures 1 and 2 is less than the preset speed, the AI model of the real gesture interpreter 156 determines that there is a probability that an occurrence of the real gesture 1 is followed by an occurrence of the real gesture 2 or by occurrences of the real gestures 1 and 2 to be performed by the user 1 when the virtual character C2 controlled by the user 2 is about to serve in the volleyball video game.

In the example, the AI model of the real gesture interpreter 156 determines the probability based on real gesture training data received from real gesture capturers of client devices operated by the other users, such as the user 2 and additional users, and the one or more of the contexts of the volleyball video game. To illustrate, upon determining that a predetermined amount of the real gesture training data indicates that a predetermined number of the other users perform one or more real gestures similar to the real gesture 2 or the real gestures 2 and 3 after performing a gesture similar to the real gesture 1, the AI model of the real gesture interpreter 156 determines that the real gesture training data indicates, with the probability, that the real gesture 1 is followed by the real gesture 2 or by the real gestures 2 and 3 to be performed by the user 1. In the illustration, the real gesture training data is received via user accounts from the client devices operated by the other users who are assigned the user accounts. Also, in the illustration, the other users make the real gesture 2 or the real gestures 2 and 3 when virtual characters controllers by the other users are about to serve virtual volleyballs in volleyball video games accessed by the other users from the server system 103.

Further, in the example, upon determining that the probability of performance of the real gesture 2 or the real gestures 2 and 3 by the user 1 exists, the AI model of the real gesture interpreter 156 determines the meanings of the real gestures 1, 2 and 3 in the same manner as that described above. Moreover, in the example, the virtual character C1 controllable by the user 1 via the client device 101 is controlled by the communication deliverer 158 to output the meanings of the real gesture 1 through 3 in the same manner as that described above to convey the meanings to the user 2. To illustrate, upon determining the meanings of the real gestures 1 through 3, the real gesture interpreter 156 provides the meanings of the real gestures 1 through 3 to the communication deliverer 158 (FIG. 1A-2). In the illustration, in response to receiving the meanings of the real gestures 1 through 3, the communication deliverer 158 generates virtual gesture data for displaying the virtual character C1 is performing the virtual gestures 1 through 3 having the meanings determined based on the real gestures 1 through 3. In the illustration, the virtual gesture data is sent from the communication deliverer 158 via the NIC 162, the computer network 105, and the NIC 107 to a display device of the client device operated by the user 2 for display of the virtual gesture data as the virtual gestures 1 through 3 being performed by the virtual character C1. In the example, the meanings are conveyed to the user 2 via the client device operated by the user 2. It should be noted that the terms preset time interval and preset time period are used herein interchangeably.

FIG. 2B is a diagram of an embodiment of a system 220 to illustrate that the server system 103 (FIG. 1A-2) generates and provides a message 222 for receiving gesture data of remaining real gestures, such as the real gesture 2 or the real gestures 2 and 3, when the user 1 takes a long time to make the remaining real gestures. The system 220 includes the display device 102 and the hand-held controller 104. Upon receiving an indication that the amount of time taken by the user 1 to make the remaining real gestures after making the real gesture 1 is greater than the preset time interval from the AI model of the of the real gesture interpreter 156 (FIG. 1A-2), the message deliverer 160 (FIG. 1A-2) generates message data, such as prompt data, to display a message requesting the user 1 via the user account 1 to make any remaining gestures, such as the real gesture 2 or the real gesture 3 or both the real gestures 2 and 3, by using another mode, such as another form, compared to a mode used by the user 1 to generate the real gesture 1. For example, the message data includes that the user 1 make the remaining gestures by using words or by moving his/her eyes instead of hands or by moving his/her hands instead of moving his/her eyes or by moving his/her head instead of hands or by moving one body part instead of another. As another example, the message data includes that the user 1 make the remaining gestures by speaking in a different language than one used in making the real gesture 1.

Upon receiving the indication that the amount of time taken by the user 1 to make the remaining real gestures after making the real gesture 1 is greater than the preset time interval from the real gesture interpreter 156, the message deliverer 160 sends a non-generation signal to the real gesture interpreter 156 not to interpret the incomplete gesture data received from the real gesture capturer 152. In response to receiving the non-generation signal, the real gesture interpreter 156 does not interpret the incomplete gesture data received from the real gesture capturer 152.

The message deliverer 160 sends the message data via the computer network 105 (FIG. 1A-2) to the client device 101 (FIG. 1A-2) operated by the user 1. Upon receiving the message data, the client device 101 outputs a message. For example, one or more speakers of the client device 101 output the message data as sound after converting the message data from an electrical signal to sound waves. As another example, the client device 101 displays the message 222 having the message data on the display device 102 of the client device 101. Upon viewing the message 222, the user 1 makes the remaining gestures, such as the real gesture 2 or the real gestures 2 and 3, using the other mode and the real gesture capturer 152 captures the remaining real gestures to generate remaining real gesture data, and sends the remaining real gesture data via the NIC 107, the computer network 105, and the NIC 162 to the real gesture interpreter 156 of the server system 103. The real gesture interpreter 156 receives the remaining real gesture data, and interprets the remaining real gestures to identify meanings of the remaining real gestures and provides the meanings to the communication deliverer 158. The communication deliverer 158 generates remaining virtual gesture data for displaying remaining virtual gestures, such as the virtual gesture 2 or the virtual gestures 2 and 3, based on the meanings of the remaining real gestures. The communication deliverer 158 sends the remaining virtual gesture data for displaying the remaining virtual gestures via the computer network 105 to the client device operated by the user 2. Upon receiving the remaining virtual gesture data for displaying the remaining virtual gestures, the client device operated by the user 2 displays the remaining virtual gestures as being performed by the virtual character C1.

FIG. 2C is a diagram of an embodiment of a system 230 to illustrate a message 232 indicating that the user 1 train himself/herself on the remaining real gestures when the user 1 takes a long time to make the remaining real gestures. The system 230 includes the display device 102 and the hand-held controller 104. Upon receiving the indication from the real gesture interpreter 156 (FIG. 1A-2) that the amount of time taken by the user 1 to make the remaining real gestures after making the real gesture 1 is greater than the preset time interval, the message deliverer 160 (FIG. 1A-2) generates message data, such as prompt data, to display the message 232 requesting the user 1 via the user account 1 to train himself/herself on the remaining gestures, such as the real gesture 2 or the real gesture 3 or both the real gestures 2 and 3, and requesting whether the user 1 wishes to start the training.

The message deliverer 160 sends the message data via the computer network 105 (FIG. 1A-2) to the client device 101 (FIG. 1A-2) operated by the user 1. Upon receiving the message data, the client device 101 outputs a message. For example, the client device 101 displays the message 232 having the message data on the display device of the client device 101. The client device 101 receives a response to the message 232 from the user 1 via the input device of the client device operated by the user 1. The response to the message 232 indicates that the user 1 wishes to train himself/herself. Upon receiving the response to the message, the client device 101 sends the response via the NIC 107, the computer network 105 and the NIC 162 to the message deliverer 160.

Upon receiving the response to the message 232 indicating that the user 1 wishes to train himself/herself, the message deliverer 160 sends a signal to the real gesture interpreter 156 (FIG. 1A-2) to provide real gesture data of the remaining real gestures. Upon receiving the signal, the AI model of the real gesture interpreter 156 provides the real gesture data of the remaining real gestures whose meanings are determined based on the incomplete gesture data, and sends the real gesture data to the real gesture data generator 109. Upon receiving the real gesture data of the remaining real gestures from the real gesture interpreter 156, the real gesture data generator 109 generates real gesture image data of the remaining real gestures. The real gesture image data is generated based on the real gesture data of the remaining real gestures. The real gesture data generator 109 sends the real gesture image data via the computer network 105 to the client device 101 to display images of the real gesture image data during a training session to train the user 1. For example, the images of the real gesture image data are displayed with or overlaid on the images of the virtual scene 108 (FIG. 1A-1).

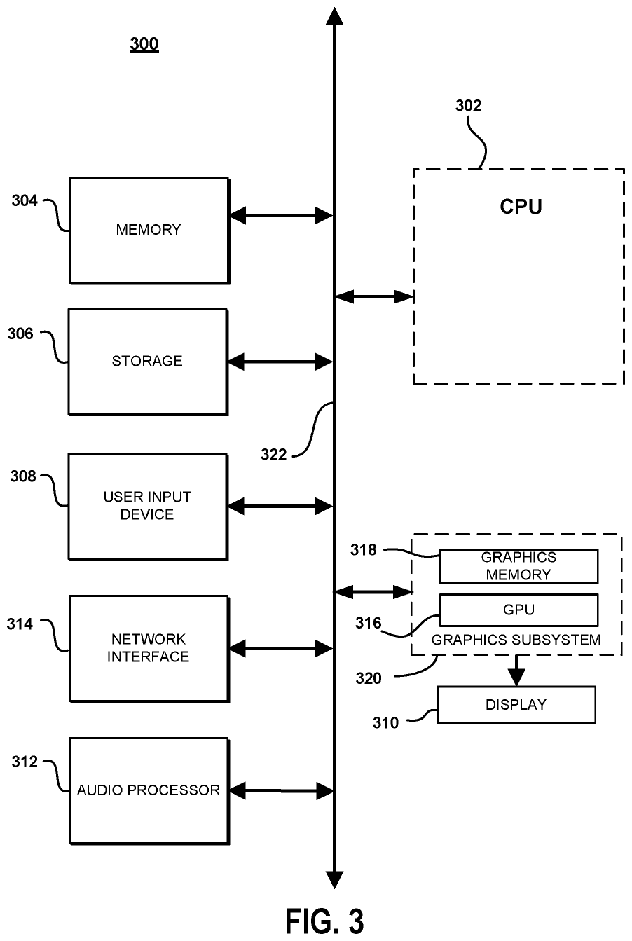

FIG. 3 illustrates components of an example device 300, such as a client device or a server system, described herein, that can be used to perform aspects of the various embodiments of the present disclosure. This block diagram illustrates the device 300 that can incorporate or can be a personal computer, a smart phone, a video game console, a personal digital assistant, a server or other digital device, suitable for practicing an embodiment of the disclosure. The device 300 includes a CPU 302 for running software applications and optionally an operating system. The CPU 302 includes one or more homogeneous or heterogeneous processing cores. For example, the CPU 302 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. The device 300 can be a localized to a player, such as a user, described herein, playing a game segment (e.g., game console), or remote from the player (e.g., back-end server processor), or one of many servers using virtualization in a game cloud system for remote streaming of gameplay to clients.

A memory 304 stores applications and data for use by the CPU 302. A storage 306 provides non-volatile storage and other computer readable media for applications and data and may include fixed disk drives, removable disk drives, flash memory devices, compact disc-read only memory (CD-ROM), digital versatile disc-ROM (DVD-ROM), Blu-ray, high definition-digital versatile disc (HD-DVD), or other optical storage devices, as well as signal transmission and storage media. User input devices 308 communicate user inputs from one or more users to the device 300. Examples of the user input devices 308 include keyboards, mouse, joysticks, touch pads, touch screens, still or video recorders/cameras, tracking devices for recognizing gestures, and/or microphones. A network interface 314, such as a NIC, allows the device 300 to communicate with other computer systems via an electronic communications network, and may include wired or wireless communication over local area networks and wide area networks, such as the internet. An audio processor 312 is adapted to generate analog or digital audio output from instructions and/or data provided by the CPU 302, the memory 304, and/or data storage 306. The components of device 300, including the CPU 302, the memory 304, the data storage 306, the user input devices 308, the network interface 314, and an audio processor 312 are connected via a data bus 322.

A graphics subsystem 320 is further connected with the data bus 322 and the components of the device 300. The graphics subsystem 320 includes a graphics processing unit (GPU) 316 and a graphics memory 318. The graphics memory 318 includes a display memory (e.g., a frame buffer) used for storing pixel data for each pixel of an output image. The graphics memory 318 can be integrated in the same device as the GPU 316, connected as a separate device with the GPU 316, and/or implemented within the memory 304. Pixel data can be provided to the graphics memory 318 directly from the CPU 302. Alternatively, the CPU 302 provides the GPU 316 with data and/or instructions defining the desired output images, from which the GPU 316 generates the pixel data of one or more output images. The data and/or instructions defining the desired output images can be stored in the memory 304 and/or the graphics memory 318. In an embodiment, the GPU 316 includes three-dimensional (3D) rendering capabilities for generating pixel data for output images from instructions and data defining the geometry, lighting, shading, texturing, motion, and/or camera parameters for a scene. The GPU 316 can further include one or more programmable execution units capable of executing shader programs.

The graphics subsystem 314 periodically outputs pixel data for an image from the graphics memory 318 to be displayed on the display device 310. The display device 310 can be any device capable of displaying visual information in response to a signal from the device 300, including a cathode ray tube (CRT) display, a liquid crystal display (LCD), a plasma display, and an organic light emitting diode (OLED) display. The device 300 can provide the display device 310 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a GPU since it will be doing a large number of relatively simple mathematical operations (e.g., matrix transformations). Other game engine segments that require fewer but more complex operations may be provisioned with a processing entity associated with one or more higher power CPUs.

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and an input/output (I/O) interface. The client device can be a personal computer (PC), a mobile phone, a netbook, a personal digital assistant (PDA), etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device system, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In an embodiment, although the embodiments described herein apply to one or more games, the embodiments apply equally as well to multimedia contexts of one or more interactive spaces, such as a metaverse.

In one embodiment, the various technical examples can be implemented using a virtual environment via the HMD. The HMD can also be referred to as a virtual reality (VR) headset. As used herein, the term “virtual reality” (VR) generally refers to user interaction with a virtual space/environment that involves viewing the virtual space through the HMD (or a VR headset) in a manner that is responsive in real-time to the movements of the HMD (as controlled by the user) to provide the sensation to the user of being in the virtual space or the metaverse. For example, the user may see a three-dimensional (3D) view of the virtual space when facing in a given direction, and when the user turns to a side and thereby turns the HMD likewise, the view to that side in the virtual space is rendered on the HMD. The HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on the HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, compact disc-read only memories (CD-ROMs), CD-recordables (CD-Rs), CD-rewritables (CD-RWs), magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

It should be noted that in various embodiments, one or more features of some embodiments described herein are combined with one or more features of one or more of remaining embodiments described herein.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for enabling communication between users, comprising:
receiving, via a computer network, data regarding a plurality of real gestures made by a first user via a first user account, wherein the data regarding the plurality of real gestures is received from a client device;
determining, from the data, whether a speed of occurrence of the plurality of real gestures is greater than a predetermined speed;
after determining that the speed of occurrence of the plurality of real gestures is greater than the predetermined speed, determining one or more meanings of a combination of the plurality of real gestures; and
communicating the one or more meanings of the combination via a virtual avatar, controlled by the first user via the first user account, to a second user.

2. The method of claim 1, wherein the combination of the plurality of real gestures includes a first gesture, a second gesture, and a third gesture, wherein said determining that the speed is greater than the predetermined speed includes determining that a time period between an occurrence of the first gesture and an occurrence of the third gesture is less than a predetermined time period.

3. The method of claim 1, wherein the combination of the plurality of real gestures includes a first gesture, a second gesture, and a third gesture, wherein said determining that the speed is greater than the predetermined speed occurs after determining that the second gesture cannot be interpreted.

4. The method of claim 1, wherein the combination of the plurality of real gestures includes a first gesture, a second gesture, and a third gesture, and the plurality of real gestures made by the first user include the first gesture and the third gesture, wherein the plurality of real gestures made by the user include a portion of the second gesture.

5. The method of claim 1, wherein the combination of the plurality of real gestures includes a first gesture, a second gesture, and a third gesture, and the plurality of real gestures made by the first user include the first gesture and the third gesture, wherein the plurality of real gestures made by the user include a portion of the second gesture or exclude the second gesture, the method further comprising:
generating prompt data requesting the first user via the first user account to perform the second gesture;
sending the prompt data via the computer network to the client device.

6. The method of claim 1, wherein the combination of the plurality of real gestures includes a first gesture, a second gesture, and a third gesture, and the plurality of real gestures made by the first user include the first gesture and the third gesture, wherein the plurality of real gestures made by the user exclude the second gesture.

7. The method of claim 1, wherein said communicating the one or more meanings of the combination via the virtual avatar includes controlling the virtual avatar to make one or more virtual gestures to convey the one or more meanings to a client device operated by the second user.

8. The method of claim 1, wherein the one or more meanings are determined based on a context of a video game, or a user profile of the first user, or a user profile of the second user, or a combination thereof.

9. A method for enabling communication between users, comprising:
receiving, via a computer network, data regarding one or more real gestures made by a first user via a first user account;
determining, from the data, whether a speed of occurrence of the one or more real gestures is less than a preset speed;
after determining that the speed of occurrence of the one or more real gestures is less than the preset speed, determining one or more meanings of the one or more real gestures; and
communicating the one or more meanings via a virtual avatar, controlled by the first user via the first user account, to a second user.

10. The method of claim 9, wherein the one or more real gestures include a first gesture and a portion of a second gesture, wherein said determining that the speed is greater than the preset speed includes determining that a time period between the occurrence of the first gesture and the portion of the second gesture is greater than a predetermined time period.

11. The method of claim 10, further comprising:
generating prompt data requesting the first user via the first user account to make the second gesture using a different mode than a mode used to make the first gesture;
receiving the second gesture via the different mode, wherein the one or more meanings are determined based on the second gesture received via the different mode.

12. The method of claim 10, further comprising:
generating prompt data requesting the first user via the first user account to be trained to learn the second gesture;
training the first user via the first user account to learn the second gesture.

13. A server system for enabling communication between users, comprising:
a processor configured to:
receive, via a computer network, data regarding a plurality of real gestures made by a first user via a first user account, wherein the data regarding the plurality of real gestures is received from a client device;
determine, from the data, whether a speed of occurrence of the plurality of real gestures is greater than a predetermined speed;
after the determination that the speed of occurrence of the plurality of real gestures is greater than the predetermined speed, determine one or more meanings of a combination of the plurality of real gestures; and
communicate the one or more meanings of the combination via a virtual avatar, controlled by the first user via the first user account, to a second user; and
a memory device coupled to the processor.

14. The server system of claim 13, wherein the combination of the plurality of real gestures includes a first gesture, a second gesture, and a third gesture, wherein to determine that the speed is greater than the predetermined speed, the processor is configured to determine that a time period between an occurrence of the first gesture and an occurrence of the third gesture is less than a predetermined time period.

15. The server system of claim 13, wherein the combination of the plurality of real gestures includes a first gesture, a second gesture, and a third gesture, wherein the processor is configured to determine that the second gesture cannot be interpreted, wherein the determination that the speed is greater than the predetermined speed occurs after the determination that the second gesture cannot be interpreted.

16. The server system of claim 13, wherein the combination of the plurality of real gestures includes a first gesture, a second gesture, and a third gesture, and the plurality of real gestures made by the first user include the first gesture and the third gesture, wherein the plurality of real gestures made by the user include a portion of the second gesture.

17. The server system of claim 13, wherein the combination of the plurality of real gestures includes a first gesture, a second gesture, and a third gesture, and the plurality of real gestures made by the first user include the first gesture and the third gesture, wherein the plurality of real gestures made by the user include a portion of the second gesture or exclude the second gesture, wherein the processor is further configured to:
generate prompt data requesting the first user via the first user account to perform the second gesture;
send the prompt data via the computer network to the client device.

18. The server system of claim 13, wherein the combination of the plurality of real gestures includes a first gesture, a second gesture, and a third gesture, and the plurality of real gestures made by the first user include the first gesture and the third gesture, wherein the plurality of real gestures made by the user exclude the second gesture.

19. The server system of claim 13, wherein to communicate the one or more meanings of the combination via the virtual avatar, the processor is configured to control the virtual avatar to make one or more virtual gestures to convey the one or more meanings to a client device operated by the second user.

20. The server system of claim 13, wherein the one or more meanings are determined based on a context of a video game, or a user profile of the first user, or a user profile of the second user, or a combination thereof.
